(19) United States
(12) Patent Application Publication
(10) Pub. No.: US 2011/0239674 A1
(43) Pub. Date: Oct. 6, 2011

(54) Joint and Feeding Assembly for an Air Conditioning Circuit

(75) Inventor: Roberto Defilippi, Torino (IT)

(73) Assignee: Dytech-Dynamic Fluid Technologies S.p.A, Torino (IT)

(21) Appl. No.: 12/994,913

(22) PCT Filed: May 26, 2009
(86) PCT No.: PCT/IB09/05711

§ 371 Date: Jun. 21, 2011

(30) Foreign Application Priority Data
May 27, 2008 (IT) T02008A000403

(51) Int. Cl. B60H 1/32; F16L 33/30; F16L 21/02

(52) U.S. Cl. 62/244; 285/345; 285/337

(57) ABSTRACT

A joint for a refrigerant adduction circuit defines a seat adapted to house an o-ring and comprises a first annular projection defining a first inclined surface tapered towards the seat, a second annular projection defining a second inclined surface tapered towards the seat, in which the first annular projection is axially between the seat and the second annular projection.

### TECHNICAL FIELD

The present invention relates to a joint and an adduction assembly for an air conditioning circuit of a motor vehicle.

### BACKGROUND ART

Motor vehicle air conditioning systems are circuits through which refrigerant flows. They are formed by a plurality of components, comprising in particular a compressor, a condenser, a drying tank, an expander system and an evaporator. All of these components are connected together by means of tubular elements which have at the ends thereof fastening elements and joint means which ensure watertightness.

The constitutive components of the air conditioning system are housed within the engine compartment of the vehicle, with the compressor drawn by the drive shaft of the motor vehicle, while the other components are fixed to portions of the body. In the air conditioning system, there are low pressure and high pressure elements. The latter may be subjected in use to pressures of the refrigerant on the order of 30 bars.

The refrigerant that has long been used for motor vehicles is a Freon gas known as “R-134”. To overcome the polluting properties of this gas, it is especially important that a pipe for the adduction of this gas is substantially impermeable thereto. Furthermore, a low permeability is also desirable so that the system maintains its functionality and efficiency in the course of time.

However, international environmental regulations impose that alternative solutions to Freon R-134 having a lower global warming potential (GWP) are sought. Among these, 1234 YS gas available from Honeywell and Dupont has proven effective. However, even by using a lower GWP gas as refrigerant, it is still of the utmost importance that the elements, i.e. pipes and joints for its adduction, have the lowest possible permeability thereto, together with satisfactory high pressure mechanical properties, in particular after a long wear and substantially for the whole life cycle of the motor vehicle.

In particular, car manufacturers impose that the lines formed by pipes and joints intended to be used for the adduction of the refrigerant in the air conditioning system overcome a plurality of experimental tests, for instance heat burst tests to verify the mechanical features thereof, cyclic pressure variation resistance tests, tests for the permeability to the fluid to be transported and resistance tests to chemical agents.

Generally, in air conditioning systems in the car manufacturing field, such requirements are satisfied by using, for the adduction of refrigerant, aluminium pipes at which ends brazed flanges and intermediate rubber pipes with bell joints or snap-fits moulded on the rubber itself are provided, possibly using this metal in combination with multilayer rubber pipes.

However, the general tendency in the car manufacturing field is to replace, where possible, the metal or rubber pipes with equivalent structures made of plastic, so as to reduce manufacturing costs as well as the overall weight of the resulting air conditioning system and also have a corresponding benefit for the CO₂ emissions in the engine in virtue of the lower consumptions.

As a consequence of the use of a plastic pipe for an air conditioning circuit the need arises to manufacture a pressure joint that allows to maintain all of the requirements of the connection methods used when the pipe is made of aluminium.

### DISCLOSURE OF INVENTION

It is the object of the present invention to therefore manufacture a joint and an adduction assembly capable of effectively replacing the elements based on the use of aluminium currently used in the air conditioning systems in the automotive field.

According to the present invention, a joint and an adduction assembly for an air conditioning circuit are made respectively according to claims 1 and 5.

### BRIEF DESCRIPTION OF THE DRAWINGS

For a better understanding of the present invention, it will further be described with reference to the accompanying figures, in particular:

FIG. 1 is a diagram of an air conditioning circuit;

FIG. 2 is a perspective view of a refrigerant adduction assembly of the circuit of FIG. 1; and

FIG. 3 is an axial section of a joint according to the present invention.

### BEST MODE FOR CARRYING OUT THE INVENTION

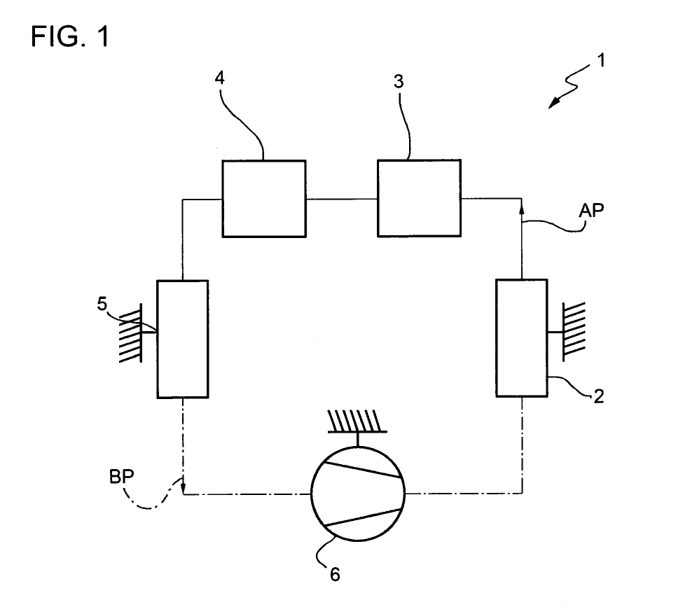

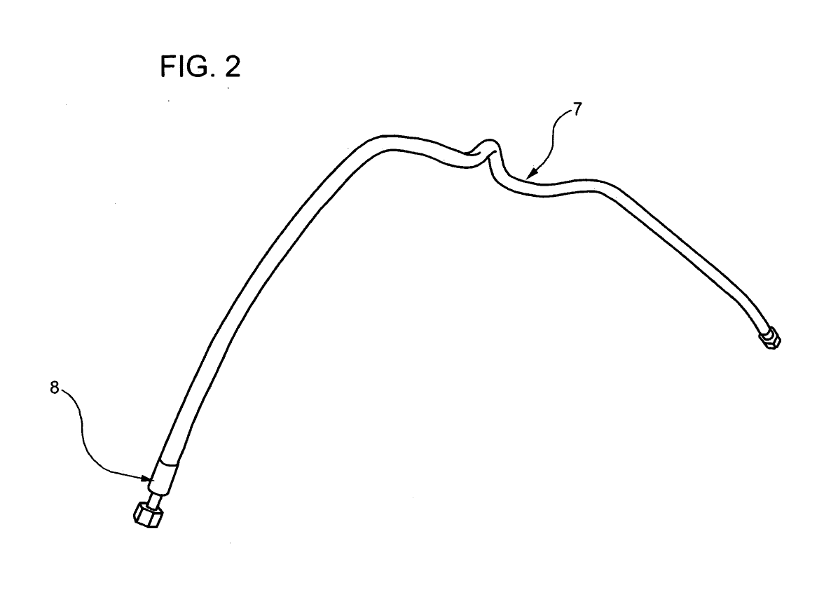

In FIG. 1 numeral 1 indicates as a whole an air conditioning system for a motor vehicle, comprising a condenser 2, a drying tank 3, an expander system 4, an evaporator 5, a compressor 6. A low pressure section BP is identified in FIG. 1 by a slash-dot line. A solid line instead indicates a high pressure section AP, substantially identifiable between compressor 6 and expander system 4. In the high pressure section AP the refrigerant (R-134) is used at temperatures around 100° C. and at a pressure on the order of 20 bars. The components of the air conditioning system shown in FIG. 1 are connected together by a plurality of hollow components, i.e. pipes 7 and respective joints 8 (FIG. 2).

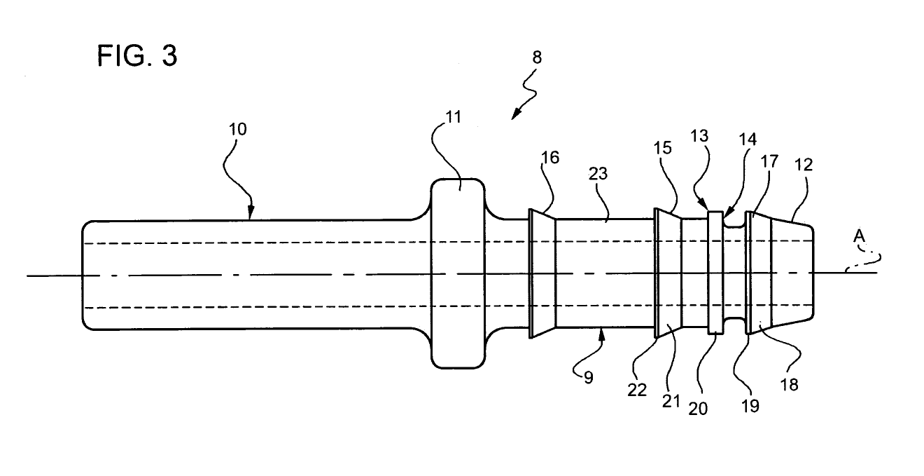

Joint 8 (FIG. 3) comprises a tubular portion 9 inserted within the pipe, a tubular portion 10 axially extending from the pipe and a flange 11 interposed between tubular portions 9 and 10 and defining an axial abutment for the pipe.

Tubular portion 9 comprises, in the order, a frustoconical lead-in portion 12, a portion 13 defining a seat 14 for an o-ring (not shown), an annular protrusion 15 adjacent to portion 13 and an annular protrusion 16 adjacent to flange 11.

In particular, seat 14 has a first side defined by an annular protrusion 17 defined by an inclined surface 18 tapered towards lead-in portion 12 and a cylindrical surface 19 arranged on the side opposite to lead-in portion 12 with respect to inclined surface 18. Seat 14 further has a second side facing the first side and defined by an annular cylindrical projection 20 having the same diameter as cylindrical surface 19.

Preferably, annular projection 15 and annular projection 16 are the same and each has an inclined surface 21 tapered towards lead-in portion 12 and a cylindrical surface segment 22 having the same diameter as the maximum diameter of inclined surface 21.

Preferably, the maximum diameter of projections 15, 16 is greater than the diameter of cylindrical surfaces 19, 20.

Furthermore, annular projections 15, 16 are axially distanced by a cylindrical surface 23 having a diameter longer than the bottom diameter of seat 14 and an axial length longer than that of a clamp.

According to a preferred embodiment, joint 8 comprises a layer comprising a thermoplastic copolymer comprising a polyamide 6,10.

Preferably, the layer comprising polyamide 6,10 comprises more than 60% polyamide 6,10. More preferably, the layer comprises more than 90% polyamide 6,10. Even more preferably, the layer is totally formed by polyamide 6,10.

Preferably, polyamide 6,10 comprises more than 60% of a copolymer obtained from a first monomer comprising units of sebacic acid and a second monomer comprising units of hexamethylenediamine. More preferably, polyamide 6,10 comprises more than 90% of a copolymer obtained from a first monomer comprising units of sebacic acid and a second monomer comprising units of hexamethylenediamine. Even more preferably, polyamide 6,10 consists of a copolymer obtained from a first monomer comprising units of sebacic acid and a second monomer comprising units of hexamethylenediamine.

Preferably, a resin of the Grilamid® S series produced by EMS is used. For instance, the Grilamid® S FR5347 resin may be used.

This resin, having a density of about 1.07 g/cm³, has a melting point equivalent to about 220° C. and a Young's module of about 2.3 GPa. As well as marked properties of chemical resistance to oils, for instance PAG2 or POE, to combustibles, to water and to saline solutions, a joint made of this resin also has good properties of short-term thermal resistance and resistance to hydrolysis, reduced tendency to absorb water, and a better mechanical stability and resistance to abrasion, with respect to pipes made of other polyamides such as PA6 and PA12.

Furthermore, as one of its constitutive monomeric units is mainly sebacic acid, a compound naturally available in great amounts as it may be obtained from castor oil, its use advantageously consists in a form of use of renewable resources. Preferably, joint 8 comprises a fibre filler, more preferably a glass fibre filler.

Preferably the glass fibres are added in an amount in weight between 10 and 60% with respect to polyamide. Optimal results in the tests have been obtained with a weight percentage in the range between 20 and 40%, for instance 30%.

According to a preferred embodiment of the invention, the glass fibres have a length in the range between 0.05 and 1.0 mm, but even more preferably have a length in the range between 0.1 and 0.5 mm.

Furthermore, these fibres preferably have a diameter in the range between 5 and 20 μm, and more preferably have a diameter in the range between 6 and 14 μm.

Preferably, joint 1 comprises at least 60% of such polyamide 6,10 filled with glass fibres. More preferably, joint 1 comprises at least 90% of such polyamide 6,10 filled with glass fibres. Even more preferably, it is totally made of such polyamide 6,10 filled with glass fibres.

Preferably, the pipe that may be mounted on joint 8 has a radial stiffness over 25 N/mm̂2, more advantageously over 50 N/mm̂2 and even more advantageously in the range between 100 and 125 N/mm̂2 and such a value may be obtained both by a single layer of material and by multilayer materials. To allow a correct coupling with the pipe having this stiffness, the diameter of cylindrical surface 22, when ‘D’ is the diameter of cylindrical surface 22 and ‘d’ is the inner diameter of pipe 7, the following relation is advantageously satisfied:

1.25d<D<1.40d.

In particular, the value of the radial stiffness of the pipe is obtained by means of a test that consists in cutting a length of pipe of 100±1 mm and in arranging this length of pipe on a dynamometer that compresses the pipe between two flat faces at a rate of 25 mm/min. The test is completed when the two faces are distanced by a distance equivalent to half of the outer diameter of the non-deformed pipe. The force thereby indicated by the dynamometer is divided by the transversal area of the wall of the pipe.

According to an embodiment, the pipe is formed by a single layer comprising polyamide 6,10 not filled with glass fibres according to what has been disclosed in the previous paragraphs and preferably has a thickness between 1.5 and 3 mm.

According to an alternative embodiment of the invention, the pipe further comprises a second layer comprising a polyamide resin preferably selected from polyamide 12 and a copolyamide obtained from dicarboxylic units which are terephthalic acid or isophthalic acid by more than 60%.

Preferably, the second layer comprises at least 60% of said polyamide resin. More preferably, the second layer comprises at least 90% of said polyamide resin. Even more preferably, the second layer is entirely made of said polyamide resin.

According to an embodiment of the invention, said polyamide resin is a polyamide 12 modified to resist cold impacts.

Preferably, polyamide 12 is selected so as to have a melting temperature in the range between 170 and 176° C., a tensile strength in the range between 25 and 35 MPa, a bending strength in the range between 20 and 30 MPa, a bending modulus in the range between 400 and 600 MPa, an impact strength in the range between 100 and 120 kJ/m² at 23° C. and between 10 and 20 kJ/m² at −40° C.

Preferably, the pipe comprises a first layer comprising polyamide 6,10 and a second layer comprising polyamide 12, the first layer being internal to the second layer.

According to a further embodiment of the invention, this copolyamide is a polyphtalamide (PPA).

Preferably, this copolyamide is a copolymer obtained from dicarboxylic units which are terephthalic acid by more than 60% and from diamine units which are 1,9-nonandiamine or 2-methyl-1,8-ottandiamine by more than 60%.

More preferably, the dicarboxylic units are terephthalic acid by more than 90%. Even more preferably, terephthalic acid forms 100% of the dicarboxylic units.

Preferably, the diamine units are 1,9-nonandiamine or 2-methyl-1,8-ottandiamine by more than 60%. More preferably, the diamine units are 1,9-nonandiamine or 2-methyl-1,8-ottandiamine by more than 90%. Even more preferably, 1,9-nonandiamine or 2-methyl-1,8-ottandiamine form 100% of the diamine units.

Examples of dicarboxylic units other than terephthalic acid comprise aliphatic dicarboxylic acids such as malonic acid, dimethylmalonic acid, succinic acid, glutaric acid, adipic acid, 2-methyladipic acid, trimethyladipic acid, pimelic acid, 2,2-dimethylglutaric acid, 3,3-diethylsuccinic acid, azelaic acid, sebacic acid and suberic acid; alicyclic dicarboxylic acids such as 1,3-cyclopentandicarboxylic acid and 1,4-cycloesandicarboxylic acid; aromatic dicarboxylic acids such as isophthalic acid, 2,6-naphthalendicarboxylic acid, 2,7-naphthalendicarboxylic acid, 1,3-phenylendioxydiacetic acid, diphenic acid, 4,4′-oxydibenzoic acid, diphenylmethane-4,4′-dicarboxylic acid, diphenylsulphone-4,4′-dicarboxylic acid and 4,4′-biphenyldicarboxylic acid; or a mixture thereof.

Among these, aromatic dicarboxylic acids are preferred.

Examples of diamine units other than the above mentioned 1,9-nonandiamine and 2-methyl-1,8-ottandiamine comprise aliphatic diamines such as ethylenediamine, propylenediamine, 1,4-butandiamine, 1,6-hexanediamine, 1,8-octanediamine, 1,10-decandiamine, 3-methyl-1,5-pentanediamine; alicyclic diamines such as cyclohexanediamine, methylcyclohexanediamine and isophorondiamine; aromatic diamines such as p-phenylenediamine, m-phenylenediamine, p-xylenediamine, m-xylenediamine, 4,4′-diaminodiphenylmethane, 4,4′-diaminodiphenylsulphone, 4,4′-diaminodiphenyl ether; and an arbitrary mixture thereof.

Such a polyamide is preferably P9T of the type disclosed in U.S. Pat. No. 6,989,198. More preferably, the polyamide resin is a Genestar® resin developed by Kuraray. Even more preferably it is a Genestar® resin developed by Kuraray, such as Genestar 1001 U03, U83, or H31.

The adduction assembly comprising joint 8 and the pipe according to the previous paragraphs meets the requirements of car manufacturers for the use of air-conditioning systems. In particular, the layer made of PA 6,10 can meet the requirements of permeability and resistance to pressure oscillations, even after aging. Furthermore, the coupling of the layer made of PA 6,10 with an outer layer made of PA12, PPA or P9T allows to overcome the problems connected to the resistance to chemical attack avoiding chipping and breaking at weldings or to the limited resistance of the threading.

### Example 1

A single-layer pipe made of Grilamid S FE 5347 7x11 having a stiffness of about 112 N/mm̂2 mounted on a joint 8 of Grilamid S FE 5347 7x11 with 40% glass fibres, in which cylindrical surface 22 has a diameter of 9.5 mm and a length shorter than 0.1 mm, has been subjected to a series of lab tests and its performance and properties have been compared to those of pipes made according to different structures known in the art.

### Heat Burst Tests

The tests have been carried out at a temperature of 120° C., after stabilisation for 1 h at the test temperature. An increasing hydraulic pressure has been applied on the previously disclosed pipe, with an increase of 5 bar/s (1.66 bar/s) until the pipe burst. The pressure at which the burst occurs is therefore compared with the values recommended for use for instance by a car manufacturer.

A pressure between 75 and 85 bars, which is significantly more than the recommended 30 bars, has been recorded for the pipe according to the invention. The test was also repeated after pulsed pressure tests (disclosed in the following), resulting in a value of 67-68 bars—still significantly over the recommended 30 bars—being recorded.

### Permeability Tests

These tests have the aim of measuring by the weight loss the amount of fluid that flows out through the wall of the pipes. In order to obtain a statistically significant result, the tests are carried out on 4 pipes at the same time.

The lengths (L₁, L₂ . . . L₄) of the tested pipes, except for the joints, are first of all measured at an atmospheric pressure. Two closing devices, one of which is provided with a filling valve, are mounted on the ends of the pipes.

The inner theoretical volume of the first 3 pipes is computed and an amount of HFC134 of 0.55 g/cm³ which is equivalent to about 50% of the inner volume of the tested pipe is introduced therein. A halogen detector is used to verify that there are no leakages from the closing devices.

The 4 pipes (3 full ones and a blank sample) are introduced in an environmental chamber at a temperature of 100° C. for 1 h, and the test is repeated with the halogen detector. At this point, the 4 pipes are conditioned in the environmental chamber at a 100° C. for 24 h.

When this step of conditioning is completed, the pipes are weighted and the values P₁, P₂, . . . P₄ are recorded.

Then, the pipes are again conditioned at 100° C. for 72 h, after which they are weighted and the single weight losses ΔPᵢ are determined. The weight loss of the pipes filled with refrigerant is therefore assessed as the average value on the three pipes, and the value detected for the “blank” pipe is subtracted thereto. The resulting difference is the permeability index in g/m²/72 h.

A value in the range between 1.82 and 2.73 g/m²/72 h has been recorded for the pipe according to the invention.

### Pulsed Pressure Resistance Tests

The tested pipes are mounted on a test bench provided with a device allowing to send pressure pulses. The pipes, mounted like a U with a radius of curvature equivalent to the minimum provided for the tested pipe, are internally filled with the lubricant provided for the compressor or with a silicone oil; the environment, in which the test is performed, contains air. Inner fluid and air are taken to a temperature of 100-120° C. and subjected to cycles with test pressure equivalent to 0±3.5 MPa (or between 0 and 1 MPa, depending on the kind of pipe), with a test frequency of 15 cycles a minute. At least 150,000 cycles are carried out, which are to be continued up to fracture when the same has not occurred within 150,000 cycles.

A verification cycle is performed at the end, by removing the pipe from the test bench, dipping it in water, and sending a pneumatic pressure of 3.5 MPa for 30 s checking that there are no leakages. In case bubbles are formed, the pressure is maintained for 5 minutes, in order to verify that it is really a leakage and not, for example, air which is trapped between the layers of the pipe (in case of a multilayer pipe).

When the analysis is completed, pipe samples are sectioned at the end joint areas and visually examined to verify there are no tears on the inner duct. The occurrence of this kind of defect would be a reason to fail the test.

No fractures have occurred for the pipe according to the invention after 150,000 cycles.

### Eradication Tests

The tests are carried out at a room temperature without any clamp at a strain rate of 25 mm/min and after the above specified pulsed pressure resistance test. The average value of the eradication load which in all cases resulted in the rupture of the pipe is 3111N.

Only adduction assemblies according to the invention pass all the tests required to ensure a long-enough life of the pipe according to the needs of car manufacturers.

The advantages the joint and the adduction assembly according to the present invention allow to obtain are the following.

The combination of a pair of radial projections 15, 16 and of the seat 14 for an o-ring results in an appropriate tightness for a high pressure application. In particular, the o-ring is effective in order to avoid leakages following a relative rotation of the joint with respect to the pipe and the radial projections 15, 16 ensure a grip that allows to pass the eradication and burst tests.

According to a preferred embodiment, cylindrical surfaces 22 have an axial length shorter than 0.15 mm. Thereby, projections 15, 16 ensure an effective tightness and grip against the wall of the pipe made of thermoplastic material so that the eradication load meets the requirements needed. This value is indeed the compromise between the opposite needs of “gripping” the thermoplastic material of the pipe without damaging it so that the burst and eradication tests are passed.

Preferably, cylindrical surface 23 has an axial length which is more than twice the axial length of the inclined surface 21. Even more preferably, the length of cylindrical surface 23 is more than 3.5 times the length of the inclined surface 21. For example, the length of cylindrical surface 21 is more than 7 mm.

Thereby, a clamp may be used as further restraining means for the pipe on tubular portion 9. Furthermore, the thermoplastic material of the pipe has the room to radially relax between projection 15 and projection 16 increasing both tightness and grip.

An adduction assembly totally made of thermoplastic material reduces weights and costs with respect to a traditional steel pipe.

1. A joint for a refrigerant adduction circuit, wherein a seat adapted to house an o-ring and comprising a first annular projection defining a first inclined surface tapered towards said seat, a second annular projection defining a second inclined surface tapered towards said seat, said second annular projection being on the opposite axial side of said seat with respect to said first annular projection (16).

2. The joint according to claim 1, wherein at least one of said annular projections further defines a cylindrical surface having a diameter equivalent to the maximum diameter of said annular projection and an axial length shorter than 0.15 mm.

3. The joint according to claim 1, wherein said first and second annular projection are distanced by at least twice the axial dimension of said first annular projection from a third cylindrical surface.

4. The joint according to claim 3, wherein said first and second annular projections are distanced by at least 6 mm.

5. An adduction assembly for a refrigerant, wherein a joint according claim 1 and a pipe inserted on said joint, wherein said pipe and joint comprise a thermoplastic material.

6. The assembly according to claim 5, wherein said pipe has a radial stiffness over 25 N/mm̂2, in that said pipe has an inner diameter ‘d’ in the range between 6 and 17 mm and in that a maximum diameter ‘D’ of at least one of said annular projections is given by the relation:
1.25d<D<1.40d.

7. The assembly according to claim 6, wherein said radial stiffness is over 50 N/mm̂2.

8. The assembly according to claim 7, wherein said radial stiffness is in the range between 100 and 125 N/mm̂2.

9. The adduction assembly according to claim 5, wherein said thermoplastic material is a polyamide.

10. The adduction assembly according to claim 9, wherein said thermoplastic material is a polyamide 6,10.

11. The adduction assembly according to claim 10, wherein said pipe consists of a single layer of polyamide 6,10.

12. The adduction assembly according to claim 11, wherein said pipe has a wall thickness in the range between 1.5 mm and 3 mm.

13. The adduction assembly according to claim 5, comprising a clamp to radially constrain said pipe to said joint.

14. A refrigerant adduction system in a motor vehicle comprising a joint according to claim 1.

15. A refrigerant adduction system in a motor vehicle comprising an adduction assembly according to claim 5.
